(19) United States
(12) Patent Application Publication
(10) Pub. No.: US 2021/0347434 A1
(43) Pub. Date: Nov. 11, 2021

(54) UPRIGHT SINGLE-WHEELED ELECTROMOTIVE APPARATUS

(71) Applicant: Hong Gwan Lee, uijeongbu-si Gyeonggi-do (KR)

(72) Inventor: Hong Gwan Lee, uijeongbu-si Gyeonggi-do (KR)

(21) Appl. No.: 17/286,465

(22) PCT Filed: Oct. 22, 2019
(86) PCT No.: PCT/KR2019/013884

§ 371 Date: Apr. 18, 2021

(30) Foreign Application Priority Data
Oct. 24, 2018 (KR) 10-2018-0127488

(51) Int. Cl. B62K 11/00; B62K 1/00; B62L 1/00; B62L 1/04

(52) U.S. Cl. CPC B62K 11/007; B62L 1/04; B62L 1/005; B62K 1/00

(57) ABSTRACT

The present invention relates to an upright single-wheeled electromotive apparatus, the upright single-wheeled electromotive apparatus according to an embodiment of the present invention comprising: a handle part having a speed-controlling means on one side; an upper frame connected to the handle part and extending lengthwise, and accommodating a battery therein; a brake connected to the upper frame; a drive unit connected to the brake, and rotates a roller; a pair of lower frames for supporting the upper frame while fixing the brake and drive unit on the inner side thereof; a wheel, positioned between the pair of lower frames, which, when the upper frame moves in one direction with respect to a reference position, stops rotating due to the brake coming into contact with the outer surface of the wheel, and when the upper frame moves in the other direction with respect to the reference position, rotates due to the roller of the drive unit coming into contact with the outer surface of the wheel; and a control unit for varying the rotational speed of the drive unit by means of the speed-controlling means.

### FIELD OF INVENTION

The present invention relates to an upright single-wheeled electromotive device, and a technique for braking and driving operations using a standing frame as a lever is disclosed.

### BACKGROUND OF INVENTION

Conventionally, various vehicles, such as a two-wheeled or four-wheeled vehicle, and a manually operated or electric motor-driven bicycle have been developed as transportation means (for a person to move on board). However, since automobiles usually use fossil fuels, next-generation vehicles such as electric vehicles and fuel cell vehicles that can replace fossil fuels are being developed. In Korea, the above devices have been developed in recent years due to increased interest in technological development for addressing environmental problems or low-pollution energy.

On the other hand, Korean Patent Registration No. 10-1651790 (registered on Aug. 22, 2016) discloses a unicycle moving with a single wheel that has a frame connecting a wheel axle and a saddle to the wheel, as well as a 180° angle pedal driven by manpower, whereby the unicycle may be substantially used for leisure sports by riding the unicycle with a sense of balance, but is substantially not used as a popular means of transportation.

In addition, a two-wheel electric personal vehicle such as a Segway has also recently been developed. Further, a unicycle type electric wheel with electric power has been developed. The present inventor has devised an electric power-driven upright type single-wheeled electromotive device which is driven by a single wheel as in the form of a conventional unicycle electric wheel.

### SUMMARY OF INVENTION

### Technical Problem to be Solved

The present disclosure has been devised on the above grounds, and an object of the present disclosure is to provide an upright single-wheeled electromotive device capable of driving or braking a standing (or upright) frame by operation of a lever.

Another object of the present invention is to provide an upright single-wheeled electromotive device having a simpler structure with excellent driving and braking abilities while requiring lower cost than the prior art.

A further object of the present invention is to provide an upright single-wheeled electromotive device that can be additionally driven to correspond to inclination of a road or can generate electricity.

### Technical Solution

An upright single-wheeled electromotive device according to an embodiment of the present invention may include: a handle member which is provided with a speed control means on one side thereof; an upper frame connected to the handle member in a longitudinal direction, which accommodates a battery therein; a brake connected to the upper frame; a drive unit connected to the brake, which rotates a roller; a pair of lower frames which supports the upper frame while fixing the brake and the drive unit on an inner side thereof; a wheel positioned between the pair of lower frames so that, when the upper frame moves to one side with respect to a reference position, the brake comes into contact with an outer surface of the wheel to brake rotation of the wheel and, when the upper frame moves to the other side with respect to the reference position, the roller of the drive unit comes into contact with the outer surface of the wheel to rotate the wheel; and a control unit for varying a rotational speed of the drive unit by the speed control means.

In addition, the upright single-wheeled electromotive device according to an embodiment of the present invention may further include: a sensor unit to sense a speed of the upper frame; and an auxiliary brake provided between the pair of lower frames to press a disk at a lateral side of the wheel to thus brake rotation of the wheel, wherein, when the speed of the upper frame exceeds a predetermined level, the control unit operates the auxiliary brake while the brake comes into contact with the wheel, simultaneously, so as to completely brake rotation of the wheel.

In addition, the upright single-wheeled electromotive device according to an embodiment of the present invention may further include: a sensor unit to sense a slope (or inclination) of the upper frame; and an auxiliary drive unit provided between the pair of lower frames to rotate a central axis of the wheel, wherein, when the slope of the upper frame exceeds a predetermined level, the control unit determines that the device is in an uphill driving state and may further operate the auxiliary drive unit.

In addition, the upright single-wheeled electromotive device according to an embodiment of the present invention may further include a sensor unit to sense a slope of the upper frame, wherein, when the slope of the upper frame is less than a predetermined level, the control unit determines that the device is in a downhill driving state and may operate the drive unit in a power generation mode, so as to charge the battery.

In addition, the upright single-wheeled electromotive device according to an embodiment of the present invention may further include: a pair of foldable pedal members provided on the pair of lower frames, respectively; and a sensor unit provided on the pedal member to sense the weight of a user, wherein the control unit may vary the rotational speed of the roller of the drive unit according to weight information sensed from the pair of foldable pedal members.

### Effect of Invention

Accordingly, the standing frame can be driven or braked in a lever operating mode, thereby enabling easy operation of the device.

Further, excellent driving and braking abilities can be achieved by a simpler structure and with lower cost than the prior art.

In addition, depending on inclination of a road, additional driving may be possible or power generation may be possible.

### BRIEF DESCRIPTION OF DRAWINGS

FIG. 1 is a configuration diagram illustrating an upright single-wheeled electromotive device according to an embodiment of the present invention.

FIG. 2 is an exemplary view to explain the operation of the brake and the drive unit in a front view of the upright single-wheeled electromotive device shown in FIG. 1.

FIG. 3 illustrates a further embodiment of the upright single-wheeled electromotive device shown in FIG. 1.

FIG. 4 is an exemplary view to explain driving with a pair of wheels in the further embodiment of the upright single-wheeled electromotive device shown in FIG. 3.

### PREFERRED EMBODIMENTS OF INVENTION

Hereinafter, preferred embodiments of the present invention will be described in detail with reference to the accompanying drawings. However, those skilled in the art will understand that the embodiments of the present invention may be modified in various forms, and the scope of the present invention is not limited to the embodiments described below. With regard to components in the following description, a singular expression is not limited to the singular form but includes the plural form. A shape and size of elements in the drawings may be exaggerated for clearer description, and the same or similar reference numerals are assigned to the same or similar parts throughout the drawings.

[symbol]

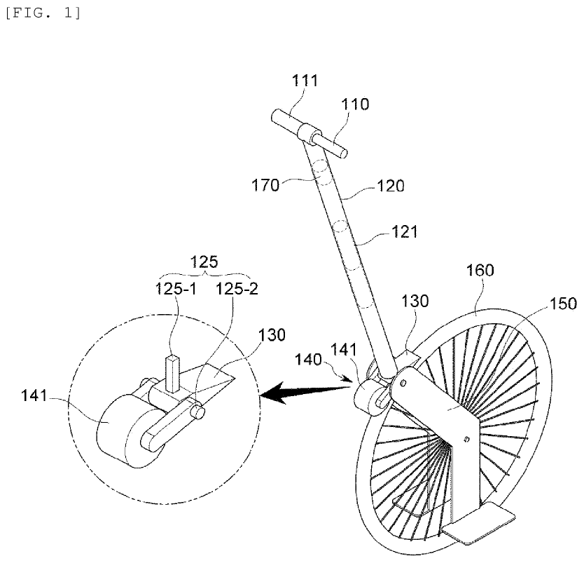

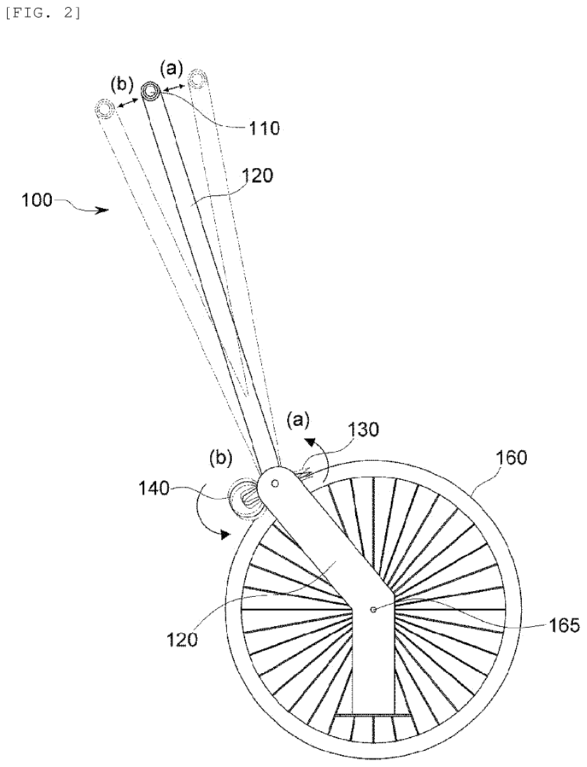

FIG. 1 is a configuration diagram illustrating an upright single-wheeled electromotive device according to an embodiment of the present invention, and FIG. 2 is an exemplary view to explain the operation of the brake and the drive unit in a front view of the upright single-wheeled electromotive device shown in FIG. 1.

Referring to FIGS. 1 and 2, the upright single-wheeled electromotive device 100 of the present invention may include a handle member 110, an upper frame 120, a brake 130, a drive unit 140, a pair of lower frames 150, a wheel 160 and a control unit 170.

The handle member 110 may be provided on an upper portion of the upper frame 120, and is preferably formed such that a user can grip the same with both hands. A speed control means 111 may be provided on one side of the handle member 110. The speed control means 111 may serve to adjust the output of the drive unit 140 through the control unit 170 by a mechanical or electronic switch. The control unit 170 may be provided on one side of the handle member 110, but is not limited thereto. A shape and size of the handle member 110 may be set and changed by the user.

The upper frame 120 may be connected to the handle member 110, have an upright form in a longitudinal direction and accommodate the battery 121 therein. The upper frame 120 may be integrated or a plurality of frames may be inserted and withdrawn to adjust a length of the device. A built-in battery 121 may be accommodated inside the upper frame 120. The battery 121 may have a size to be accommodated in the upper frame 120, or may be formed in a detachable structure that can be mounted outside. The upper frame 120 may be formed in a separate structure that can be removed from the brake 130 and the drive unit 140. In this case, since the upper frame 120 is chargeable separately, only the upper frame 120 may be carried and charged if required.

Further, the upper frame 120 is connected to the brake 130 and the drive unit 140. For example, the central axis 125 of the upper frame 120 may be formed in a ‘⊥’ shape, wherein the upper frame 120 is coupled to a ‘l’-shaped portion as a vertical central axis 125-1 while the brake 130 and the drive unit 140 are connected to a ‘-’ portion as a horizontal central axis 125-2. The upper frame 120 may rotate at a predetermined angle in a space between the pair of lower frames 150, which will be described later.

Referring to FIG. 2, when the upper frame 120 moves to one side with respect to a reference position as shown in (a), the brake 130 may come into contact with an outer surface of the wheel 160 so as to brake rotation of the wheel. Herein, the reference position means a position at which the brake 130 and the drive unit 140 do not contact the wheel 160 in an idle state. In addition, as shown in (b), when the upper frame 120 moves from the reference position to the other side, that is, the opposite side, the drive unit 140 may rotate the wheel 160 while coming into contact with the outer surface of the wheel 160. The upper frame 120 may serve as a lever that controls rotation and braking of the wheel 160.

The brake 130 is connected to the central axis 125 of the upper frame 120 and brakes rotation of the wheel 160 while coming into contact with the outer surface of the wheel 160. The brake 130 may be positioned opposite to the drive unit 140 and move while being connected to each other. Specifically, the brake 130 is positioned such that the wheel 160 faces a side abutting the ground surface. Specifically, the brake 130 is in contact with the side of the wheel 160 abutting the ground surface, and may be formed of a flexible material having durability, such as a rubber material, without limitation thereof. For example, the brake may also be formed of a metal material. The brake 130 is not in contact with the wheel 160 when the upper frame 120 is at the reference position in conjunction with the central axis of the upper frame 120. Further, the brake may come into contact with the outer surface of the wheel 160 when the upper frame moves to one side from the reference position. On the contrary, when the upper frame 120 moves to the other side opposite to the above side from the reference position, the brake does not come into contact with the outer surface of the wheel 160.

The drive unit 140 may move while being coupled to the brake 130. The drive unit 140 rotates the roller 141. The drive unit 140 is positioned to face the brake 130, and the roller 141 is positioned to face a contact surface where the wheel 160 abuts the ground surface. In other words, the drive unit 140 does not directly drive the wheel 160 but indirectly drives the same by rotating the roller 141 in contact with the outer surface of the wheel 160. In the drive unit 140, the roller 141 may not be in contact with the wheel 160 when the upper frame 120 is at the reference position or is moved to one side. Further, the roller 141 of the drive unit 140 may come into contact with the wheel 160 to rotate the same when the upper frame 120 moves to the other side opposite to the above side. In this case, the roller 141 comes into contact with the wheel 160 when the upper frame 120 moves from the reference position in a predetermined range to the other side. A rotational speed of the roller 141 may vary by the speed control means 111.

In addition, the drive unit 140 may be separated from the brake 130 and disposed on an axle of the wheel 160 to rotate the same. In this case, the brake 130 is connected to the central axis 125 of the upper frame 120, and brakes rotation of the wheel 160 while contacting the outer surface of the wheel 160.

A pair of lower frames 150 may face each other and support the upper frame 120 while fixing the brake 130 and the drive unit 140 therein. Specifically, the pair of lower frames 150 may support the upper frame 120 by fixing both sides of a horizontal central axis 125-2 in the central axis 125 of the upper frame 120. Further, the brake 130 and the drive unit 140 connected to the central axis 125 are also fixed. In this case, the upper frame 120 may rotate from one side to the other side in the pair of lower frames 150. When the upper frame 120 moves from the reference position to one side, the brake 130 may come into contact with the outer surface of the wheel 160 to brake rotation of the wheel. On the other hand, when the upper frame moves to the other side, the roller 141 of the drive unit 140 may come into contact with the outer surface of the wheel 160 to rotate the wheel.

In other words, the pair of lower frames 150 may also serve to guide a rotational direction of the upper frame 120. In addition, the pair of lower frames 150 may support the wheel 160 by fixing a wheel axle 165 therein.

Further, a cover 155 may be provided on one side or both sides of the pair of lower frames 150. The cover 155 is configured to partially cover an upper portion of the wheel 160 to protect the user. The cover 155 may be provided in a detachable form on the pair of lower frames 150. The cover 155 may serve to prevent dirt on the wheel 160 from splashing onto the user and to prevent the user from being injured by rotation of the wheel 160.

The wheel 160 is disposed between the pair of lower frames 150. The wheel axle 165 of the wheel 160 is fixed between the lower frames 150. A width and size of the wheel 160 may be set and altered by the user. The wheel 160 is braked when the outer surface of the wheel is in contact with the brake 130. Further, when the outer surface of the wheel comes into contact with the roller 141 of the drive unit 140, the wheel 160 may rotate. More particularly, when the upper frame 120 moves from the reference position to one side, the brake 130 abuts a contact surface of the wheel 160 to restrict rotation thereof. In this case, the roller 141 of the drive unit 140 is spaced apart from the wheel 160 and thus does not transmit rotational force. When the upper frame 120 moves from the reference position to the other side, contact between the brake 130 and the wheel 160 is released and the roller 141 of the drive unit 140 abuts the contact surface of the wheel 160, thereby rotating the wheel 160.

The control unit 170 may change the rotational speed of the drive unit 140 by the speed control means 111. The control unit 170 may control the rotational speed of the wheel 160 by adjusting a rotational speed of the roller 141 of the drive unit 140. Further, the control unit 170 may detect a charge amount of the battery 121 present inside the upper frame 120 and output a warning sound when the charge amount is less than a predetermined level. In addition, the control unit 170 may communicate with an external user terminal. Further, the control unit 170 may output the charging amount information of the battery 121 in the upright single-wheeled electromotive device 100 to the user terminal. In addition, the drive unit 140 may be operated only after pairing with the user terminal through Bluetooth communication or the like. The purpose of the above configuration is to allow the upright single-wheeled electromotive device to be used only by authorized users.

[symbol]

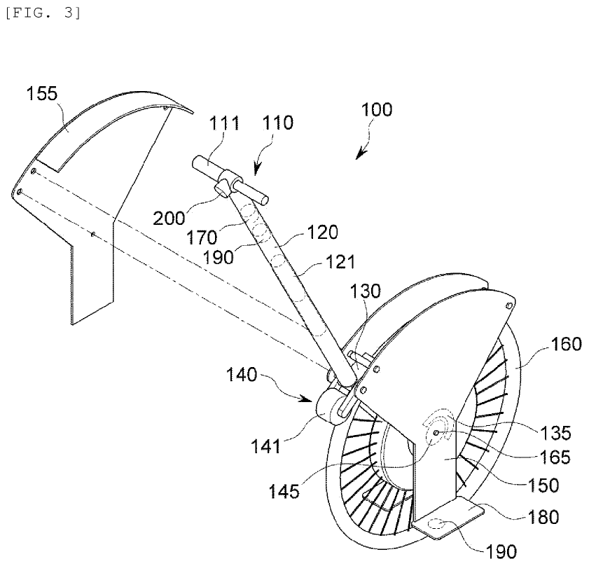

FIG. 3 illustrates a further embodiment of the upright single-wheeled electromotive device shown in FIG. 1.

Referring to FIG. 3, the upright single-wheeled electromotive device 100 according to another embodiment of the present invention may further include a sensor unit 190. The sensor unit 190 may sense a moving speed of the upper frame 120, a slope of the upper frame 120 or a weight applied to the lower frame 150. The sensor unit 190 may generate sensing information for driving mode, stop mode and braking mode on the basis of the moving speed and the slope of the upper frame 120. Further, if the sensor unit 190 is provided on a pedal member, the control unit 170 may sense the weight of the user. The purpose of this configuration is to obtain weight information of the user and change the driving speed of the drive unit 140.

[symbol]

On the other hand, the upright single-wheeled electromotive device 100 according to another embodiment of the present invention may further include an auxiliary brake 135. The auxiliary brake 135 is provided between the pair of lower frames 150 to press a disk at a lateral side of the wheel 160 to thus brake rotation of the wheel. This is a method of pressing the wheel or pressing the lateral side of the wheel rather than a contact surface between the wheel 160 and the ground surface. The auxiliary brake 135 is an auxiliary braking means configured to act together with the brake 130, thereby enhancing braking force.

In this regard, if a speed of the upper frame 120 exceeds a predetermined level, the control unit 170 may drive the auxiliary brake 135 simultaneously with the brake 130 abutting the wheel 160, thereby completely braking rotation. The purpose of this configuration is to additionally use the auxiliary brake 135 in order to improve braking force when the upright single-wheeled electromotive device 100 is accelerated beyond a predetermined speed.

[symbol]

On the other hand, the upright single-wheeled electromotive device 100 according to another embodiment of the present invention may further include an auxiliary drive unit 145. The auxiliary drive unit 145 may be provided between the pair of lower frames 150 to rotate the central axis 125 of the wheel 160. The auxiliary drive unit 145 may transmit driving force to the wheel axle 165 of the wheel 160 using a general electric motor and rotate the same. Unlike the drive unit 140 that drives the wheel 160 in contact with the outer surface of the wheel, the auxiliary drive unit 145 may rotate the wheel axle 165 to further increase rotational force.

In this case, if the slope of the upper frame 120 exceeds a predetermined level, the control unit 170 determines that the device is in an uphill driving state and thus may further operate the auxiliary drive unit 145. The purpose of this configuration is to increase driving force through the auxiliary drive unit 145 if the driving force of the upright single-wheeled electromotive device 100 (sometimes abbrev. to “the device”) decreases due to uphill driving, whereby the device can ride uphill. The control unit 170 may simultaneously or separately operate the drive unit and the auxiliary drive unit 145 on the basis of inclination of the upper frame 120.

Further, if the slope of the upper frame 120 is less than a predetermined level, the control unit 170 determines that the device is in a downhill driving state and thus may operate the drive unit in a power generation mode in order to charge the battery 121. More particularly, when the device 100 rides downhill, the roller 141 of the drive unit 140 does not rotate but undergoes reverse rotation by rotation of the wheel 160, thereby generating power. In this regard, electricity is induced by reverse rotation of the roller 141 and can be used to charge the battery 121. Accordingly, it is possible to charge the battery 121 while reducing power consumption, thereby extending duration of use.

[symbol]

Alternatively, the upright single-wheeled electromotive device 100 according to another embodiment of the present invention may further include a pedal member 180. Specifically, a pair of foldable pedal members 180 may be provided on the pair of lower frames 150, respectively. The pedal member 180 may have a hinge structure to be folded or unfolded. The user may use the pedal member 180 in unfolded state when riding the device 100, while folding the pedal member 180 during storage. A size and shape of the pedal member 180 may be set and changed by the user. The pedal member 180 may be provided with a sensor unit 190 to acquire weight information of the user.

In this regard, the control unit 170 may vary a rotational speed of the roller 141 of the drive unit 140 on the basis of the weight information sensed by the pair of pedal members 180. The purpose of this configuration is to increase or decrease the driving force according to the weight information since a moving speed of the device 100 varies according to the weight information of the user even with the same driving force. In addition, the control unit 170 may further operate the auxiliary drive unit 145 according to the weight information when the auxiliary drive unit 145 is provided in the upright single-wheeled electromotive device 100. Therefore, the driving force may be increased according to information on the weight of a user, thereby driving the device at a predetermined speed or higher.

[symbol]

Alternatively, the upright single-wheeled electromotive device 100 according to another embodiment of the present invention may further include a lighting unit 200.

The lighting unit 200 may output light in a traveling direction of the device 100. The lighting unit 200 may output light in a preset flashing pattern. In this case, the sensor unit 190 may detect external illumination and, when an intensity of the illumination is less than a predetermined level, may automatically output light to secure a driving visual field. In addition, the sensor unit 190 may also detect sound in addition to ambient illumination. The sensor unit 190 may detect ambient sound information at a preset time interval and output the detected sound information to the control unit 170.

In this regard, the control unit 170 may control the output of the lighting unit 200 by comparing ambient illumination information and sound information through the sensor unit 190. For example, the control unit 170 may control the output of the lighting unit 200 in a vehicle surrounding mode and a people surrounding mode based on the illumination information and the sound information. The vehicle surrounding mode is a mode in which sound information is analyzed by frequency in order to output light when a vehicle's horn, driving sound and engine sound are detected, and a preset flashing pattern is output to warn the driver of the vehicle. On the other hand, the people surrounding mode is a mode in which sound information is analyzed by frequency in order to output light when a vehicle-related sound is not detected, and a preset blinking pattern is output to warn pedestrians. Accordingly, the flashing pattern may vary according to the ambient illumination or sound to guarantee safety of the user, the other driver and/or the pedestrian.

[symbol]

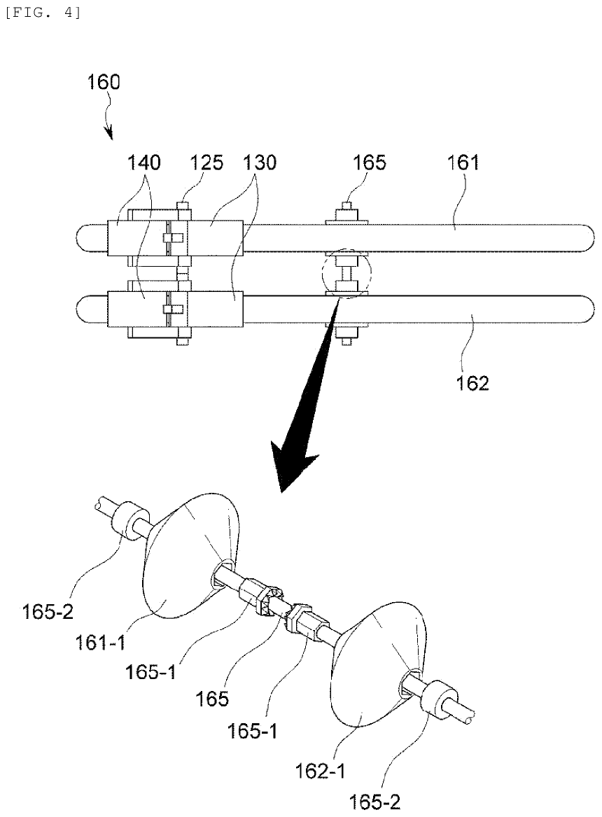

FIG. 4 is an exemplary view to explain driving with a pair of wheels in the further embodiment of the upright single-wheeled electromotive device shown in FIG. 3.

Referring to FIG. 4, the wheel 160 of the upright single-wheeled electromotive device 100 according to another embodiment of the present invention may also be configured in the form of paired wheels. In other words, a first wheel 161 and a second wheel 162 are connected to the same wheel axle 165 side by side to face each other. The purpose of this configuration is to increase driving stability of the device 100 and facilitate directional change. The first wheel 161 and the second wheel 162, respectively, may be formed to come into contact with the brake 130 and the drive unit 140, so as to independently adjust speed. In this case, it is preferable to provide separate speed control means corresponding to the first wheel 161 and the second wheel 162, respectively.

Further, the first wheel 161 and the second wheel 162 may rotate in conjunction with each other. For example, the wheel axle 165 is inserted through a first wheel body 161-1 of the first wheel 161 and a second wheel body 162-1 of the second wheel 162. In this case, wheel bolts 165-1, which are male and female-coupled to each other, may be inserted between the first wheel body 161-1 and the second wheel body 162-1 facing each other. Each wheel bolt 165-1 may have a polygonal structure in cross section so that one side of the wheel bolt is inserted into the first wheel body 161-1 or the second wheel body 162-1, while male and female protrusions are formed on the other side. Bearings 165-2 may be formed outside the first wheel body 161-1 and the second wheel body 162-1 in order to prevent release of the wheel and minimize friction. Accordingly, when the first wheel 161 rotates, the second wheel 162 may rotate in conjunction with the same. In addition, the first wheel 161 and the second wheel 162, respectively, may be formed to come into contact with the brake 130 and the drive unit 140.

[symbol]

As described above, the present invention has been described by means of preferred embodiments with reference to the drawings, but is not limited thereto. Therefore, the present invention should be interpreted by the description of the appended claims intended to embrace obvious variations possibly derived from the described examples.

1. An upright single-wheeled electromotive device, comprising:
a handle member which is provided with a speed control means on one side thereof;
an upper frame connected to the handle member in a longitudinal direction, which accommodates a battery therein;
a brake connected to the upper frame;
a drive unit connected to the brake, which rotates a roller;
a pair of lower frames which supports the upper frame while fixing the brake and the drive unit on an inner side thereof;
a wheel positioned between the pair of lower frames so that, when the upper frame moves to one side with respect to a reference position, the brake comes into contact with an outer surface of the wheel to brake rotation of the wheel and, when the upper frame moves to another side with respect to the reference position, the roller of the drive unit comes into contact with the outer surface of the wheel to rotate the wheel; and
a control unit for varying a rotational speed of the drive unit by the speed control means.

2. The device according to claim 1, further comprising:
a sensor unit to sense a speed of the upper frame; and
an auxiliary brake provided between the pair of lower frames to press a disk at a lateral side of the wheel to thus brake rotation of the wheel,
wherein, when the speed of the upper frame exceeds a predetermined level, the control unit drives the auxiliary brake while the brake comes into contact with the wheel, simultaneously, so as to completely brake rotation of the wheel.

3. The device according to claim 1, further comprising:
a sensor unit to sense a slope of the upper frame; and
an auxiliary drive unit provided between the pair of lower frames to rotate a central axis of the wheel,
wherein, when the slope of the upper frame exceeds a predetermined level, the control unit determines that the device is in an uphill driving state and further operates the auxiliary drive unit.

4. The device according to claim 1, further comprising:
a sensor unit to sense a slope of the upper frame,
wherein, when the slope of the upper frame is less than a predetermined level, the control unit determines that the device is in a downhill driving state and operates the drive unit in a power generation mode, so as to charge the battery.

5. The device according to claim 1, further comprising:
a pair of foldable pedal members provided on the pair of lower frames, respectively; and
a sensor unit provided on the pedal member to sense the weight of a user,
wherein the control unit varies the rotational speed of the roller of the drive unit depending on weight information sensed from the pair of foldable pedal members.
